(19) United States
(12) Patent Application Publication
(10) Pub. No.: US 2006/0041497 A1
(43) Pub. Date: Feb. 23, 2006

(54) Systems and methods for maintaining system performance

(75) Inventor: Kenneth Huber, Phoenixville, PA (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: PJM Interconnection, LLC., Norristown, PA (US)

(21) Appl. No.: 11/048,612

(22) Filed: Feb. 1, 2005

Related U.S. Application Data
(60) Provisional application No. 60/602,533, filed on Aug. 18, 2004.

(51) Int. Cl. G06Q 40/00; G06Q 99/00

(52) U.S. Cl. 705/37; 705/1

(57) ABSTRACT

Systems, methods and computer programs may be used to represent first and second components of a commodity transport network. A first operating characteristic value may correspond to the first component. A critical value may be received. A programmed computer may be used to determine if the first operating characteristic value is at least as great as the critical value. If so, a first representation representing the first component may be displayed. A second representation that represents an operating state of the second component may be displayed. A change in the state may correspond to a change in the first operating characteristic.

### CROSS-REFERENCE TO RELATED APPLICATION

This claims the benefit of U.S. Application No. 60/602,533, filed Aug. 18, 2004, which is hereby incorporated herein in its entirety.

### BACKGROUND OF THE INVENTION

A network for transporting a commodity, such as energy, water and gas, may operate subject to conditions—such as commodity supply or demand, or infrastructure performance—that may affect the reliability of the network. Network operators seek to maintain network reliability. As the conditions change, commodity flow through the network may require adjustment to provide an adequate amount of the commodity to customers, avoid damage to the infrastructure or ensure that other indices of reliably are maintained. Commodity flow adjustment, however, often causes the network to operate in a condition that is economically sub-optimal.

Network reliability management systems often include electronic displays that display representations of network infrastructure units. Complex networks may require the representation of thousands or hundreds of thousands of infrastructure units. Network operators may use the displays to make decisions regarding commodity input to the network, output from the network or routing within the network. When a flow adjustment causes a departure from the economically optimal operation of an infrastructure unit, it may be difficult, if not impossible, for a network operator to record the adjustment and, at an appropriate time after it is made, restore the infrastructure unit to economically optimal operation. It would therefore be desirable to provide improved systems, methods and computer programs for recording changes in the flow of a commodity to, from or within a transport network.

### SUMMARY OF THE INVENTION

It is an object of the invention to provide improved systems, methods and computer readable instructions for recording changes in the flow of a commodity to, from or within a transport network. In accordance with the principles of the invention, there are provided systems, methods and computer programs for representing first and second components of a commodity transport network. A first operating characteristic value may correspond to the first component. The invention may include receiving a critical value; using a programmed computer to determine if the first operating characteristic value is at least as great as the critical value; if the first operating characteristic value is at least as great as the critical value, displaying on a display a first representation representing the first component; and displaying on the display a second representation that represents an operating state of the second component.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is an illustrative schematic diagram of apparatus in accordance with the principles of the invention;

FIG. 2 is another illustrative schematic diagram of apparatus in accordance with the principles of the invention;

FIG. 3 is an illustrative schematic diagram of portions of the apparatus shown in FIGS. 1 and 2 and other apparatus that may be used in accordance with the principles of the invention;

FIG. 4 is an illustrative data flow chart showing a flow of data in accordance with the principles of the invention;

FIG. 5 shows an illustrative display in accordance with the principles of the invention;

FIG. 6 shows another illustrative display in accordance with the principles of the invention;

FIG. 7 shows yet another illustrative display in accordance with the principles of the invention;

FIG. 8 shows still another illustrative display in accordance with the principles of the invention;

FIG. 9 shows illustrative steps that may be performed in accordance with the principles of the invention;

FIG. 10 shows still another illustrative display in accordance with the principles of the invention;

FIG. 11 shows still another illustrative display in accordance with the principles of the invention;

FIG. 12 shows still another illustrative display in accordance with the principles of the invention; and

FIG. 13 shows still another illustrative display in accordance with the principles of the invention.

### DETAILED DESCRIPTION OF THE INVENTION

The invention may provide systems, methods and computer readable instructions for representing first and second components of a commodity transport network, a first operating characteristic value corresponding to the first component. A method according to the principles of the invention may include receiving a critical value; using a programmed computer, determining if the first operating characteristic value is at least as great as the critical value; if the first operating characteristic value is at least as great as the critical value, displaying on a display a first representation representing the first component; and displaying on the display a second representation that represents an operating state of the second component. A change in the state may correspond to a change in the first operating characteristic.

A method according to the principles of the invention may include displaying on a display a first representation of at least a portion of the first component; and using a computer, defining on the display a magnitude axis, the magnitude axis including a plurality of values; wherein a position, with respect to the axis, of the portion identifies the operating characteristic value.

A system according to the principles of the invention may include an access device configured to receive a critical value; a processor configured to determine if the first operating characteristic value is at least as great as the critical value; and a display device configured to: display a first representation representing the first component if the first operating characteristic value is at least as great as the critical value; and display a second representation that represents an operating state of the second component.

An information storage medium according to the principles of the invention may include computer readable instructions for performing a method for displaying the first and second components of the commodity transport network. The instructions may include an instruction for receiving the critical value; an instruction for determining if the first operating characteristic value is at least as great as the critical value; an instruction for displaying on a display the first representation representing the first component if the first operating characteristic value is at least as great as the critical value; and an instruction for displaying on the display the second representation that represents the operating state of the second component.

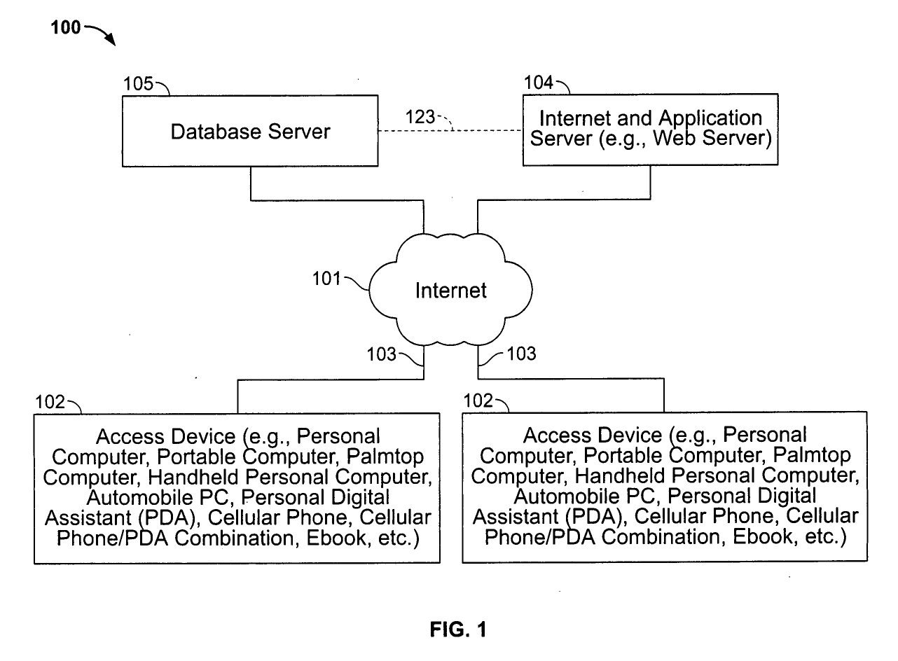

FIG. 1 shows illustrative Internet-based arrangement 100 that may include access devices 102, which may be connected via links 103 to Internet 101. (Although FIG. 1 illustrates arrangement 100 as an Internet-based arrangement, it will be understood that in some embodiments of the invention, arrangement 100 may include any suitable wide area network (“WAN”) in place of, or in addition to, Internet 101.) Access devices 102 may include any device or combination of devices suitable for providing one-or two-way communication with Internet 101. A user may be an individual or any other suitable party or entity.

Access devices may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, e-book, or other device suitable for providing Internet access.

Arrangement 100 may include Internet and application server 104, which may be any server suitable for providing Internet access to, or otherwise communicating with, a world wide web site. Internet and application server 104 may run Microsoft Internet Information Server. Internet and application server 122 may, for example, provide one or more pages to an access device 102 using one or more suitable protocols (e.g., the HyperText Transfer Protocol (HTTP) and Transmission Control Protocol/Internet Protocol (TCP/IP)).

The pages may be defined using, for example, any suitable markup language (e.g., HyperText Markup Language (HTML), Dynamic HyperText Markup Language (DHTML), pages defined using the Extensible Markup Language (XML), JavaServer Pages (JSP), Active Server Pages (ASP), or any other suitable approaches). The pages may include scripts, computer code, or subsets of computer code, that define mini-programs (e.g., Perl scripts, Java applets, Enterprise JavaBeans (EJB), or any other suitable approaches). Internet and application server 104 may support applications using any suitable modular approach such as, for example, Java 2 Platform—Enterprise Edition (J2EE), Component Object Model (COM), Distributed Component Object Model (DCOM), or any other suitable approach.

Arrangement 100 may include database server 105, which may run a database management system suitable for managing a database of transport network information. Database server 105 may include, for example, Microsoft SQL Server, Oracle, or any other suitable database management system such as a Java Database Connectivity (hereinafter, “JDBC”) compliant or an Open Database Connectivity (hereinafter, “ODBC”) compliant database management system.

Arrangement 100 may include one or more suitable processors for processing information such as the transport network information. The processors may be present in one or both of servers 104 and 105 or may be external to servers 104 and 105. Features of one or both of Internet and application server 104 and database server 105 may be integrated into a single server or may be distributed across multiple servers that are interconnected via Internet 101 or any other suitable communication network.

Links 103 may include any transmission media suitable for providing electronic communication between devices such as access devices 102 and server 105. Links 103 may provide Internet access to access devices 102. Links 103 may include, for example, a dial-up telephone line, a computer network or Internet link, an infrared link, a radio frequency link, a satellite link, a digital subscriber line link (e.g., a DSL link), a cable TV link, a DOCSIS link, or any other suitable transmission link or suitable combination of such links. Different links 103 may be of different types depending on, for example, the particular type of access devices 102. In some embodiments of the invention, direct communication link 123 may be present to enable direct communication between servers 104 and 105. Link 123 may have one or more of the features of links 103.

Any protocol or protocol stack suitable for supporting communication between access devices 102 and one or both of servers 104 and 105 over links 103 may be used. The protocol or protocol stack may be selected based on a particular device 102 and link 103. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of protocols may be used.

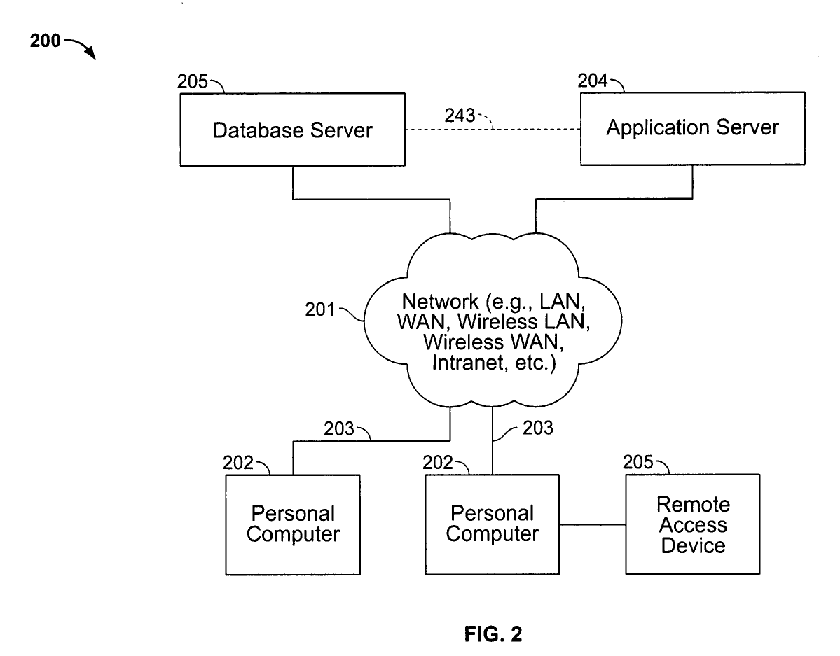

FIG. 2 shows illustrative intranet arrangement 200 that may include network 201, which may be any suitable wire-based, fiber-based or wireless local area network (“LAN”) or other suitable network. Personal computers, and their interconnection via networks, are well known. One or more of personal computers 202 may run suitable e-mail, HTTP, or other clients and client applications for providing network access to a user of arrangement 200. In a suitable approach, one or more of personal computers 202 may run suitable Internet browsers to provide users with access to the Internet via an Internet server (not shown). If desired, one or more of personal computers 202 may be accessed by remote access device 205 to provide remote access to users to the system. Remote access device 205 may be any suitable device, such as a personal computer, personal digital assistant, cellular phone, or other device with remote access capabilities.

Arrangement 200 may include application server 204, which may be any server suitable for providing access to, or otherwise communicating with a transport network analysis application and data. Application server 204 may run any suitable application, including any suitable version or versions of the applications described in connection with Internet and application server 104 (shown in FIG. 1), and may have one or more of the features of application server 122. Arrangement 200 may include database server 205, which may run a database management system suitable for managing a database of transport network information. Database server 205 may run any suitable version or versions of the applications described in connection with database server 105 (shown in FIG. 1).

Arrangement 200 may include one or more suitable processors for processing information such as the transport network information. The processors may be present in one or both of servers 204 and 205 or may be external to servers 204 and 205. Features of one or both of servers 204 and 205 may be integrated into a single server or may be distributed across multiple servers that are interconnected via network 201 or any other suitable communication network.

Links 203 may include any transmission media suitable for providing electronic communication between devices such as personal computers 202 and servers 204 and 205. Links 203 may provide network access to personal computers 202. Links 203 may include, for example, a dial-up telephone line, a computer network link, an infrared link, a radio frequency link, a satellite link, a digital subscriber line link (e.g., a DSL link), a cable TV link, a DOCSIS link, or any other suitable transmission link or suitable combination of such links. Different links 203 may be of different types depending on, for example, the particular type of personal computer 202.

In some embodiments of the invention, direct communication link 243 may be present to enable direct communication between servers 204 and 205. Link 243 may have one or more of the features of links 203.

Any protocol or protocol stack suitable for supporting communication between personal computers 202 and one or both of server 204 and 205 over links 203 may be used. The protocol or protocol stack may be selected based on a particular computer 202 and link 203. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of protocols may be used.

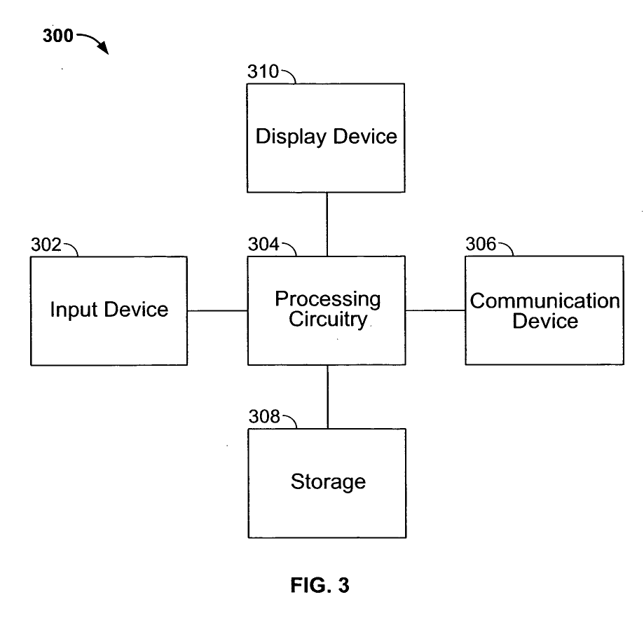

FIG. 3 shows illustrative, generalized arrangement 300 for one or more of access devices 102 (shown in FIG. 1), personal computers 202 and remote access device 205 (shown in FIG. 2). Arrangement 300 may include, for example, user input device 302, processing circuitry 304, communication device 306, storage device 308, and display device 310. User input device 302 may be any suitable input device. User input device 302 may include, for example, a pointing device, a keyboard, a scanner, a camera, a touch-pad, a touch screen, a pen stylus, a voice recognition system, a mouse, a trackball, a joystick or any other suitable user input device.

Processing circuitry 304 may include any suitable processor or processors, such as one or more of those sold under the trademarks INTEL and PENTIUM by Intel Corporation of Santa Clara, Calif., any suitable microprocessor, and any other suitable circuitry (e.g., input/output (I/O) circuitry, direct memory access (DMA) circuitry, etc.). Communication device 306 may be any device suitable for supporting communications over links 103 (shown in FIG. 1) or 203 (shown in FIG. 2). Communication device 306 may include, for example, a modem (e.g., any suitable analog or digital standard, cable, or cellular modem), a network interface card (e.g., an Ethernet card, token group card, etc.), a wireless transceiver (e.g., an infrared, radio, or any other suitable analog or digital transceiver), or any other suitable communication device. Storage device 308 may be any suitable memory, storage device, or combination thereof, such as RAM, ROM, flash memory, a hard disk drive, etc.

Display device 310 may include, for example, any suitable projection device (not shown), and/or projection screen (not shown). The screen may be a front projection screen or rear projection screen. Device 310 may include a Personal Data Assistant (PDA). Device 310 may include a back-lit display device. Device 310 may include a cathode ray tube (CRT) monitor, liquid crystal display (LCD), a plasma display or any other suitable output device.

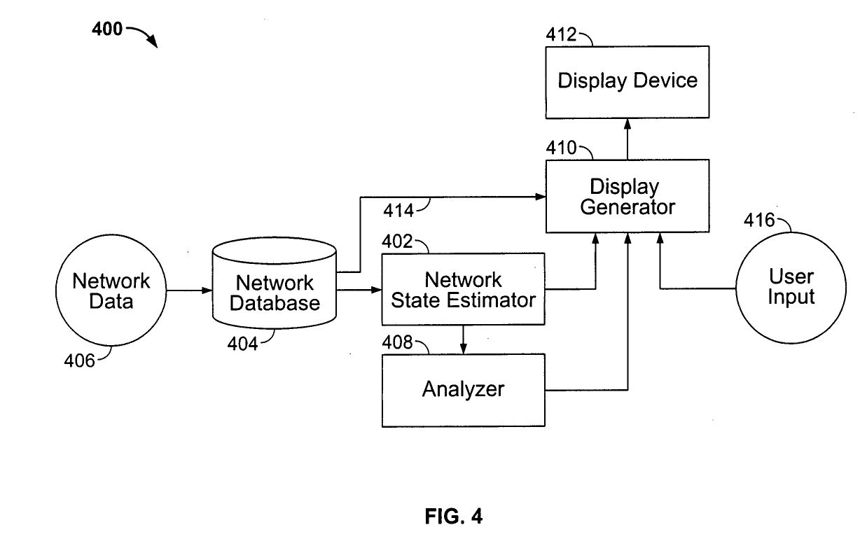

FIG. 4 shows an illustrative diagram of data flow through illustrative commodity transport network analysis system 400. For the purpose of illustration, an electric power transmission grid will be referred to herein as an illustrative network, electric power will be referred to as an illustrative commodity and the grid will be understood to be defined by one or more infrastructure units. Some of the infrastructure units may generate electric energy. Some may transport electric energy. Some may condition electric energy. Some may consume electric energy. System 400 may be implemented using any suitable device or devices, including any of the devices shown in FIGS. 1-3. System 400 may be implemented using any suitable software, including without limitation applications discussed in connection with devices shown in FIGS. 1-3.

Network state estimator 402 may be present in system 400 to receive network data 406, which may be stored in network database 404. The network data may include a valve that corresponds to an operating characteristic of one or more of the infrastructure units. The operating characteristic may be a voltage, a current, a phase angle, a temperature or any other suitable operating characteristic. The data may include Supervisory Control and Data Acquisition (“SCADA”) information. System 400 may receive the data on a “real-time” basis. The data may be received via telemetry from the infrastructure units. In some embodiments of the invention, database 404 may be on one or both of database servers 105 and 205 (shown in FIGS. 1-2). State estimator 402 may calculate operating characteristic estimates for one or more of the infrastructure units.

State estimator 402 may run an application configured to solve one or more equations that estimate the flow of electric current through from one infrastructure unit to another. Some equations may be linear equations. Some equations may be non-linear equations. Some equations may quantify an amount of power generation required to balance power generation, loads and losses in the network. The equations may be any suitable equations and may be based on electrical, mechanical, thermal or any other suitable engineering or scientific principles. Estimator 402 may provide the operating characteristic estimates to analyzer 408, which may be any suitable analyzer, including that sold under the name Spectrum by Siemens Power Transmission & Distribution, Inc. of Brooklyn Park, Minn.

Analyzer 408 may receive the estimates from estimator 402 and, based on the estimates, may simulate a condition in a portion of the network and estimate, for an infrastructure unit, an operating characteristic hypothetical valve, such as a voltage, resulting from the simulated condition. In some embodiments of the invention, analyzer 408 may simulate the condition using network data. In some embodiments of the invention, analyzer 408 may simulate the condition using the estimates. In some embodiments of the invention, analyzer 408 may simulate the condition using a combination of the estimates, the network data and any other suitable information. In some embodiments of the invention, a hypothetical value may include network data. In some embodiments of the invention, a hypothetical value may include an operating characteristic estimate. Analyzer 408 may solve numerous electrical engineering equations and may calculate hypothetical values for numerous infrastructure units for each simulated condition. It will be understood further that analyzer 408 may simulate conditions in numerous infrastructure units. The numerous conditions may include different types of conditions. One type of a condition is an infrastructure unit failure.

Some of the conditions that analyzer 408 may simulate are: an infrastructure unit retirement; an infrastructure unit addition; an infrastructure unit outage; a change in an infrastructure unit commodity flow rate; a change in an infrastructure unit commodity production rate; and a change in an infrastructure unit commodity consumption rate.

Some of the operating characteristics for which analyzer 408 may estimate a hypothetical value are: voltage (which may include MVARS), voltage stability, transient stability, current, phase and temperature. Analyzer 408 may output one or more hypothetical operating characteristic values for each infrastructure unit. Analyzer may output for each simulated condition a data set that includes a hypothetical operating characteristic value for each infrastructure unit.

Analyzer 408 may provide the hypothetical values to display generator 410, which may include any suitable software platform for generating displays, such as that sold under the trademark RETRIEVER by PowerWorld Corporation of Champaign, Ill. Display generator 410 may interface to any suitable display device. Display generator 410 may run on one or more of servers such as 104, 105, 204 and 205 (shown in FIGS. 1 and 2).

System 400 may include display device 412 for receiving display information from display generator 410 and for rendering an image corresponding to the information. Display device 412 may include any suitable device, including those such as display device 310 (shown in FIG. 3). In some embodiments of the invention, display device 412 may correspond to display device 310 (shown in FIG. 3). In some embodiments of the invention, one or more of the features of display device 412 may be included in display generator 410. In some embodiments of the invention, one or more of the features of display generator 410 may be included in display device 412.

A network topology database (not shown) may store topological data that define connections among the infrastructure units. In some embodiments of the invention, the topological data may reside in network database 404. The topological data may be provided to display generator 410. The topological data may be cross-referenced to the operating characteristic values. In some embodiments of the invention, the topological data may be used by state estimator 402 to calculate operating characteristic value estimates. In some embodiments of the invention, the topological data may be used by analyzer 408 to calculate an operating characteristic hypothetical value. Link 414 may be used to transfer topological data directly from network database 404 to display generator 410. Link 414 may be used to transfer network data directly from network database 404 to display generator 410.

User input 416 may include any suitable input, such as a selection of one or more infrastructure units that may be represented in the image. The selection may be made based on geographic location of the infrastructure units. The selection may be made based on topological relationships between infrastructure units. For example, the user input may identify a power substation. The selection may select transmission lines and breakers connected to the substation. The user input may be provided to display generator 410 using a device such as 102 or 202 (shown in FIGS. 1 and 2).

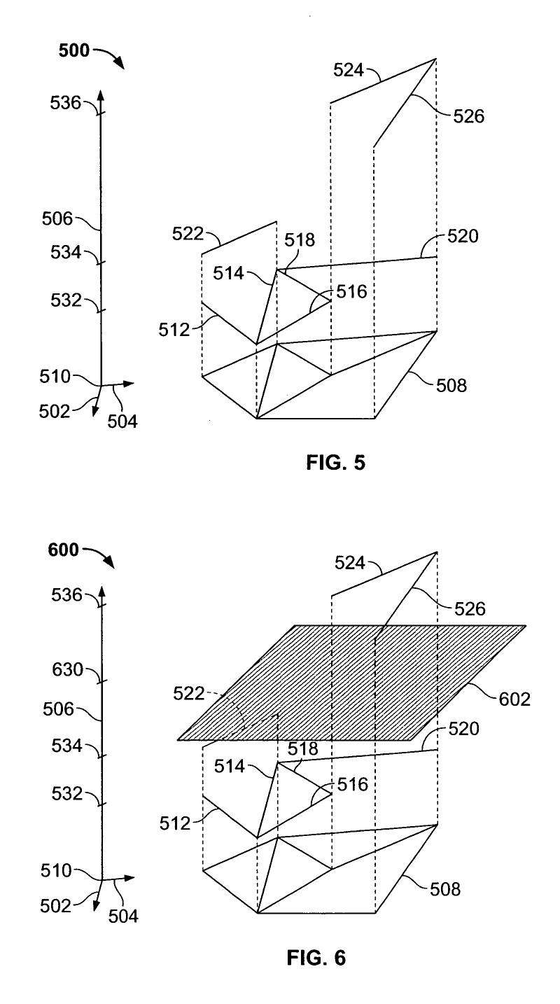

FIGS. 5-8 show illustrative views that, in some embodiments of the invention, may be displayed by a system such as 400 (shown in FIG. 4).

FIG. 5 shows view 500, which may include reference axes 502, 504 and 506. The reference axes show that view 500 is an isometric three-dimensional view, but system 400 may provide a display such as 500 with any suitable reference axes and may represent the display as viewed from any suitable angle or in any suitable coordinate system. In some embodiments of the invention, axes 502 and 504 may correspond to areal dimensions in reference to which network line diagram 508 may be represented. In some embodiments of the invention, axis 506 may represent an operating characteristic value, such as MVAR, for example.

In some embodiments of the invention, axis 506 may represent an index of an operating characteristic value, such as a percentage of a maximum operating characteristic value. For the sake of illustration, axis 506 in FIGS. 5-8 represents a percentage of a maximum operating characteristic value. For example, the value of the index at origin 510 may be 0%. The value at a point located along axis 506 above the origin may be 120%. (It will be understood that axes 502, 504 and 506 extend away from origin 510, although view 500 shows only a segment of the axes.)

Line diagram 508 may include one or more infrastructure unit representations, such as transmission line representations. View 500 shows transmission line representations 512, 514, 516, 518, 520, 522, 524 and 526 that correspond (as shown by broken lines) to transmission lines in the line diagram. Representations 512, 514, 516, 518 and 520 are shown at a position with respect to axis 506 that corresponds to position 532 on axis 506 and represents a first percentage of maximum MVARs for each respective transmission line. It will be appreciated that the actual value of MVARs may be different for each of the transmission lines represented by representations 512, 514, 516, 518 and 520, but view 500 shows that each of the transmission lines represented by 512, 514, 516, 518 and 520 are at the same percentage of their respective maximum MVARs.

Infrastructure unit information such as a maximum operating characteristic value, a geographic location or coordinate, connectivity information and any other suitable information may be stored in and/or accessed from a database, such as network database 404 (shown in FIG. 4).

View 500 shows transmission line representation 522 positioned with respect to axis 506 at a second value of percentage of maximum MVARs. (The second value corresponds to position 534 on axis 506.) The second value is greater than the first value. Transmission line representations 524 and 526 are positioned with respect to axis 506 at a third value (corresponding to position 536 on axis 506) that is greater than the first and second values.

FIG. 6 shows view 600 that may include evaluation plane 602, which may be positioned with respect to axis 506 at a critical value. The critical value may be selected by a user of system 400, for example, as part of user input 416. View 600 shows evaluation plane 602 positioned, with respect to axis 506, at a position (corresponding to position 630 on axis 506) between the second and third values. (Transmission line representation 522, shown in broken line, is below and behind evaluation plane 602 and transmission line representations 524 and 526 are above and in front of evaluation plane 602.) The user may select any suitable critical value.

In some embodiments of the invention, the user may select properties of evaluation plane 602. For example, in some embodiments, the user may select the degree to which evaluation plane 602 blocks a view of an infrastructure unit representation positioned behind or collocated with evaluation plane 602. View 600 shows an embodiment in which evaluation plane 602 is “translucent” to infrastructure unit representation 522, positioned in part behind evaluation plane 602 and shown in part in broken line.

In some embodiments of the invention, the user may select the extent, in the directions of axis 502 or 504, of evaluation plane 602. In some embodiments of the invention, the user may select the shape of evaluation plane 602. For example, the user may select the shape of evaluation plane 602 in a plane perpendicular to axis 506. For example, the shape may be rhombic, elliptical or of any other suitable shape or geometry.

In some embodiments of the invention, the user may be provided with an opportunity to include more than one evaluation plane in a view such as 600. In some of those embodiments, the multiple evaluation planes may identify infrastructure unit representations corresponding to infrastructure units represented within a range of percentages of a maximum operating characteristic value.

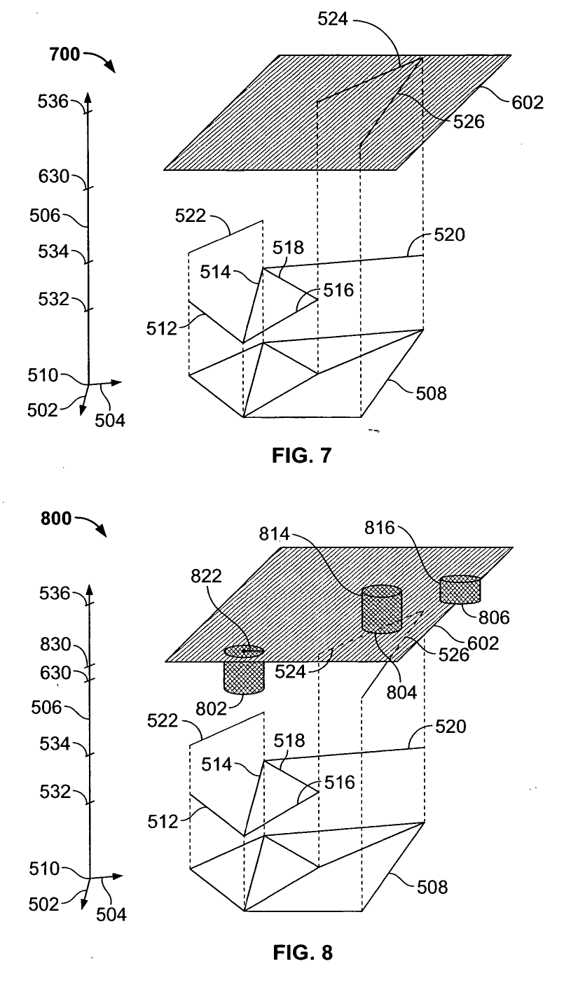

FIG. 7 shows illustrative view 700 in which evaluation plane 602 is positioned at the third position (described above), coincident with transmission line representations 524 and 526. The third position may represent a percentage of maximum MVARs for which an adjustment is desired. For example, the third position may represent a percentage of maximum MVARs that is sufficiently high to threaten the reliability of the network. The number of MVARs flowing through the transmission lines represented by transmission line representations 524 and 526 may require adjustment, which may be effected via known methods. (The known methods may include changing the rate at which electrical energy is produced by one or more generators present in the network. The effect of a change in electrical energy generation at a generator upon the flow of electrical energy in a transmission line may be quantified for one or more transmission lines in the network using known methods. An index of the effect may be known as a “distribution factor.”)

A change in electrical energy generation rate of a generator may change one or more indices associated with operating the generator. One such index may be an economic index. The economic index may be the cost of running the generator. The economic index may be the cost of operating the network. The economic index may be based on one or both of the respective costs of operating the generator and the network. The economic index may be defined in any suitable manner. The economic index may have a target value. The target value may be an economically beneficial value, which may be a minimum value.

A generator may be deliberately operated at a generation rate at which the corresponding economic index is different from the target value in order to avoid operating the network in an unreliable manner. After the electrical energy rate is adjusted, the transmission line may operate at a percentage of maximum MVARs that does not threaten network reliability. It may be desirable, however, to re-adjust the electrical energy generation rate to change the economic index to a different value that is closer to the target value. It may be desirable, however, to re-adjust the electrical energy generation rate to change the economic index to a different value that is farther from the target value. It may be desirable to change the economic index to the target value. In some instances, it may be desirable to change the economic index provided that the index can be readjusted without creating a threat to network reliability.

FIG. 8 shows view 800, which shows infrastructure unit representations after adjustment of electrical energy rates in three generators, which are represented by illustrative generator representations 802, 804 and 806, which are, for the sake of illustration, cylindrical. Generator representations such as 802, 804 and 806 may be positioned, with respect to axes 502 and 504, in positions that correspond to positions of the corresponding generators in line diagram 508. The generator representations may be positioned contiguous with evaluation plane 602. The generator representations may be positioned contiguous with the plane of line diagram 508.

Evaluation plane 602 in view 800 is in the same position, with respect to axis 506, as shown in FIG. 7. Transmission line representations 524 and 526 have moved to a new position with respect to axis 506, below evaluation plane 602 and corresponding to position 830 on axis 506. Transmission line representations 524 and 526 may move to two different new positions if the corresponding flows change differently.

Generator representations 802, 804 and 806 may be configured to represent information regarding the corresponding generators. Generator representations 802, 804 and 806 may be configured to represent information regarding the corresponding changes in electrical energy generation. Generator representations 802, 804 and 806 may be configured to represent information regarding the corresponding economic indices.

In some embodiments, a position of a generator representation with respect to evaluation plane 602 may correspond to a direction of change in an energy generation rate. For example, generator representation 802 is contiguous and below evaluation plane 602 to indicate that the corresponding generation rate was reduced. Generator representations 804 and 806 are contiguous and above evaluation plane 602 to indicate that the corresponding generation rates were increased. A length such as lengths 814 and 816 of representations 804 and 806, respectively, may be proportional to the changes in the generation rates of the corresponding generators. A length such as length 822 of representation 802 may be proportional to an economic index of the corresponding generator.

In some embodiments of the invention, the user may be provided with an opportunity to define relationships between generator representation lengths (or any other suitable dimensions or features) and generator characteristics. For example, a user may select a generator representation shape. A user may select a generator representation color. A user may associate a generator dimension (such as a length) with one or more of a generation rate, a change in a generation rate, an economic index, a change in an economic index, a quantity derived from one or more of the foregoing or any other suitable quantity or any suitable quality.

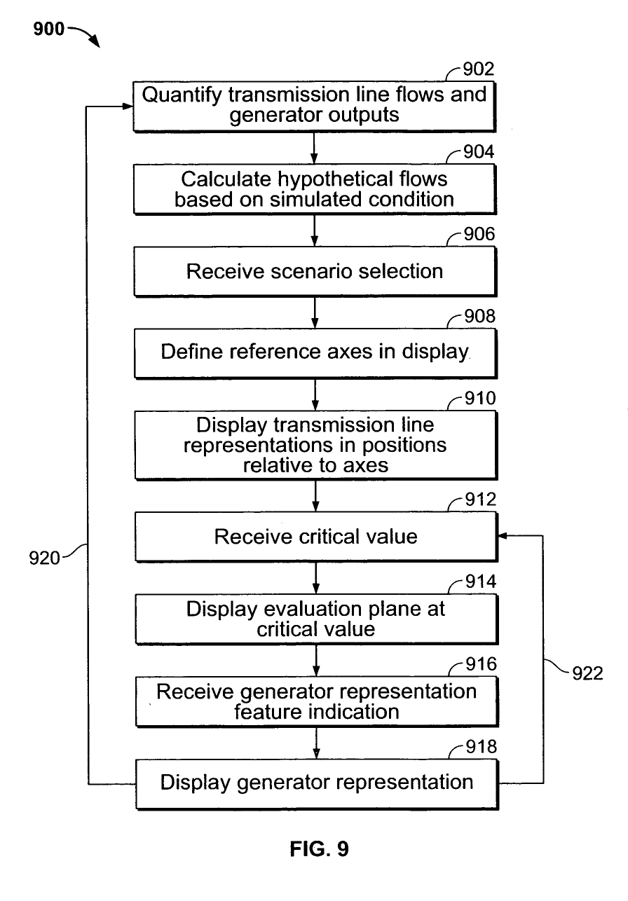

FIG. 9 shows process 900 that includes illustrative steps that may be performed for displaying representations of infrastructure units of a commodity transport network such as those illustrated in FIGS. 5-8. The steps shown in FIG. 9 are only illustrative and may be performed in any suitable order. In practice, there may be additional steps or some of the steps may be deleted. For clarity, the following discussion will describe the steps shown in FIG. 9 as being performed by a commodity transport network analysis “system,” which is intended to include any suitable information analysis system that may include, for example, all or a portion of arrangements 100, 200, and 300 (shown in FIGS. 1-3, respectively) and system 400 (shown in FIG. 4).

In step 902, the system may quantify transmission line flow values and generator output values. The values may include network data, such as 406 (shown in FIG. 4). The values may include operating characteristic estimates such as those calculated by state estimator 402, (shown in FIG. 4). In step 904, the system may calculate hypothetical values based on one or more simulated conditions. A condition may be simulated in analyzer 408. Each condition may be the basis for a set of hypothetical values of flow through the transmission lines. The set may be referred to as a scenario.

In step 906, a user may select, and the system may receive, a selection of a scenario. In step 908, the system may define reference axes with respect to which representations of the transmission lines will be displayed. The axes may correspond to axes 502, 504 and 506 (shown in FIG. 5). In step 910, the system may display one or more transmission line representations. The representations may be displayed on apparatus such as that shown in FIG. 3. In step 912, the system may receive a critical value. In some embodiments of the invention, the critical value may be the value, with respect to a reference axis, at which an evaluation plane such as 602 (shown in FIG. 6, e.g.) is displayed. (In some embodiments of the invention, the critical value may be compared to a hypothetical flow for a transmission line. In some of those embodiments, if the flow value is at or above the critical value, a representation of the corresponding transmission line may be displayed. If the flow value is below the critical value, the representation may not be displayed.)

In step 914, the system may display the evaluation plane at a position, with respect to a reference axis, corresponding to the critical value. In step 916, the system may a receive an indication of a generator representation feature (e.g., an attribute of the representation corresponding to a state of the generator). The indication may be received from a system user. In some embodiments of the invention, the indication may be an instruction to graphically represent a generator output value as a dimension of the generator representation. (For example, the user may instruct the system to make the height of the representation correspond to the generator power output.) In some embodiments of the invention, the indication may be an instruction to graphically represent a change in a generator output value as a dimension of the generator representation. (For example, the user may instruct the system to make the height of the representation correspond to a change in the generator power output.) In step 918, the system may display the generator representation. For example, the representation may be displayed as shown in FIG. 8. In some embodiments of the invention, process 900 may follow path 920 and repeat by continuing with step 902. In some embodiments of the invention, process 922 may continue with step 912. In some of those embodiments, the user may be provided with an opportunity to select a new critical value.

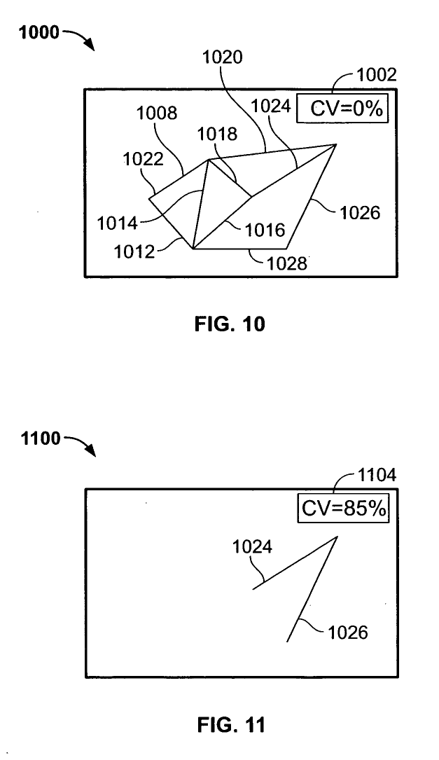

FIGS. 10-14 show illustrative views that, in some embodiments of the invention, may be displayed by a system such as 400 (shown in FIG. 4). The views in FIGS. 10-14 may include two-dimensional views of representations such as those shown in FIGS. 5-8, which in include three dimensions, as defined by reference axes 502, 504 and 506. View 1000 may include line diagram 1008, which may correspond to line diagram 508 (shown in FIG. 5). Line diagram 1008 may be a view along axis 506 (shown in FIG. 5) of line diagram 508. View 1000 may include only those transmission line representations corresponding to transmission lines having flow values that meet or exceed the critical value. The critical value may be defined as a percent of a maximum value. In view 1000, the critical value 1002 (“CV”) is 0%. The critical value may be a user-selected critical value. All of the transmission line representations in line diagram 1008 are represented because, in the example shown in FIG. 10, each of the transmission lines is associated with a non-zero flow value.

FIG. 11 shows view 1100, which illustrates a portion of a scenario that may be generated by analyzer 408 (shown in FIG. 4). View 1100 corresponds to FIG. 7 and shows only those representations in line diagram 1008 that correspond to transmission lines that have flow values of at least 85% of their maximum flow. View 1100 shows that critical value 1104 is 85%. Value 1104 may correspond to the third position, which was described in connection with FIGS. 5-8, and at which representations 524 and 526 are shown in FIGS. 5-7. Only representations 1024 and 1026 appear in view 1100 because representations 1012, 1014, 1016, 1018, 1020, 1022 and 1028 are less than value 104.

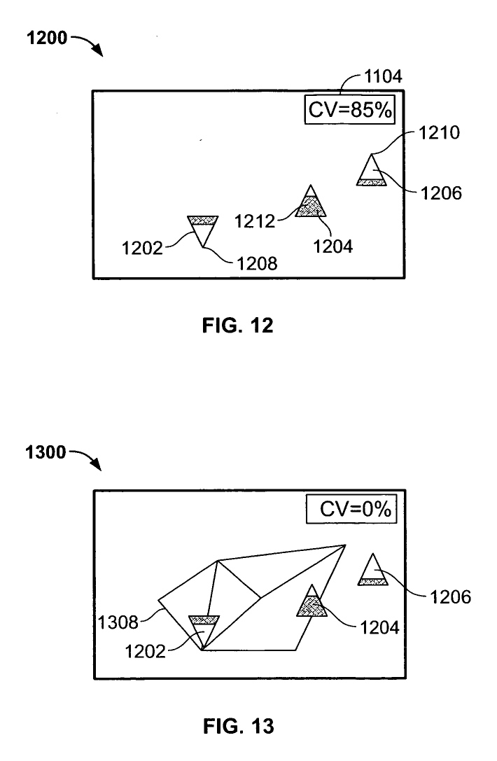

FIG. 12 shows view 1200, which may include generator representations 1202, 1204 and 1206, which may correspond respectively to generator representations 802, 804 and 806, shown in corresponding FIG. 8. Each of representations 1202, 1204 and 1206 may have one or more of the features described in connection with representations 802, 804 and 806. In the example shown in FIG. 12, representations 1202, 1204 and 1206 are triangles. One or more features of representations 1202, 1204 and 1206 may correspond to a state of a corresponding generator. One or more features of representations 1202, 1204 and 1206 may correspond to a change in a state of a corresponding generator. For example, a down-pointing triangle apex, such as apex 1208 may indicate that output for the corresponding generator was reduced. An up-pointing apex, such as apex 1210 may indicate that output for the corresponding generator was increased. Within a triangle, the extent of a shaded portion, such as shaded portion 1212, may indicate an amount by which the output of a corresponding generator was changed. The amount may be an absolute amount, such as a number of MVARs. The amount may be a relative amount, such as a percentage of a reference value of MVARs. The reference value may be a maximum output for the corresponding generator. The value may be an economically optimal value. The value may be any other suitable reference value. Transmission line representations 1024 and 1026 are not present in view 1200 because a flow reduction through the corresponding transmission lines is associated with the generator output changes corresponding to generator representations 1202, 1204 and 1206. The flow reduction, in the illustrative example of FIG. 12, reduced the flow to a value below critical value 1104.

FIG. 13 shows view 1300, which corresponds to FIG. 8 in that all transmission lines represented by line diagram 1308 are present and generator representations 1202, 1204 and 1206 are present.

Thus it is seen that systems, methods and computer programs representing first and second components of a commodity transport network have been provided. One skilled in the art will appreciate that the present invention can be practiced by other than the described embodiments, which are presented for purposes of illustration and not of limitation, and the present invention is limited only by the claims which follow.

What is claimed is:

1. A system for displaying first and second components of a commodity transport network, a first operating characteristic value corresponding to said first component, said system comprising:
a processor configured to determine if said first operating characteristic value is at least as great as a critical value; and
a display device configured to:
display a first representation representing said first component if said first operating characteristic value is at least as great as said critical value; and
display a second representation that represents an operating state of said second component, a change of said state corresponding to a change of said first operating characteristic.

2. The system of claim 1 further comprising an access device configured to receive said critical value.

3. The system of claim 1 wherein said first operating characteristic value corresponds to a first measurement made at said first component.

4. The system of claim 1 wherein said first operating characteristic value corresponds is an estimate corresponding to said first component.

5. The system of claim 4 wherein said estimate is a contingency estimate.

6. The system of claim 4 wherein said estimate is a network flow model estimate.

7. The system of claim 2 wherein:
said access device is further configured to receive a second operating characteristic value corresponding to said first component;
said display device is further configured to:
remove said first representation from said display if said second operating characteristic value is less than said critical value; and
retain said second representation in said display.

8. The system of claim 7 wherein said second operating characteristic value corresponds to a second measurement made at said first component.

9. The system of claim 7 wherein said second operating characteristic value is an estimate corresponding to said first component.

10. The system of claim 9 wherein said estimate is a contingency estimate.

11. The system of claim 9 wherein said estimate is a network flow model estimate.

12. The system of claim 1 wherein said commodity is electrical energy.

13. The system of claim 1 wherein said first component is a transmission line.

14. The system of claim 1 wherein said second component is an electric power generator.

15. The system of claim 1 further comprising calculating said change based on said state.

16. The system of claim 1 wherein said change is a predicted change.

17. The system of claim 1 further comprising a processor configured to calculate said first operating characteristic value based on a perturbation of a third operating characteristic value, said third operating characteristic value corresponding to a third component of said network.

18. The system of claim 1 wherein said first operating characteristic value is an index of reliability of said network.

19. The system of claim 18 wherein said operating state corresponds to an economic index.

20. A method for representing first and second components of a commodity transport network, a first operating characteristic value corresponding to said first component, said method comprising:
using a programmed computer, determining if said first operating characteristic value is at least as great as a critical value;
if said first operating characteristic value is at least as great as said critical value, displaying on a display a first representation representing said first component; and
displaying on said display a second representation that represents an operating state of said second component, a change of said state corresponding to a change of said first operating characteristic.

21. The method of claim 1 further comprising receiving said critical value.

22. The method of claim 20 wherein said first operating characteristic value corresponds to a first measurement made at said first component.

23. The method of claim 20 wherein said first operating characteristic value corresponds is an estimate corresponding to said first component.

24. The method of claim 23 wherein said estimate is a contingency estimate.

25. The method of claim 23 wherein said estimate is a network flow model estimate.

26. The method of claim 21 further comprising:
receiving a second operating characteristic value corresponding to said first component;
if said second operating characteristic value is less than said critical value, removing said first representation from said display; and
retaining said second representation in said display.

27. The method of claim 26 wherein said second operating characteristic value corresponds to a second measurement made at said first component.

28. The method of claim 26 wherein said second operating characteristic value is an estimate corresponding to said first component.

29. The method of claim 28 wherein said estimate is a contingency estimate.

30. The method of claim 28 wherein said estimate is a network flow model estimate.

31. The method of claim 20 wherein said commodity is electrical energy.

32. The method of claim 20 wherein said first component is a transmission line.

33. The method of claim 20 wherein said second component is an electric power generator.

34. The method of claim 20 further comprising calculating said change based on said state.

35. The method of claim 30 wherein said change is a predicted change.

36. The method of claim 20 further comprising calculating said first operating characteristic value based on a perturbation of a third operating characteristic value, said third operating characteristic value corresponding to a third component of said network.

37. The method of claim 20 wherein said first operating characteristic value is an index of reliability of said network.

38. The method of claim 37 wherein said operating state corresponds to an economic index.

39. An information storage medium comprising machine readable instructions for performing a method for representing first and second components of a commodity transport network, a first operating characteristic value corresponding to said first component, said instructions comprising:
an instruction for determining if said first operating characteristic value is at least as great as a critical value;
an instruction for displaying on a display a first representation representing said first component if said first operating characteristic value is at least as great as said critical value; and
an instruction for displaying on said display a second representation that represents said second component and indicates an operating state of said second component, said state corresponding to a change in said first operating characteristic.

40. The medium of claim 39 further comprising an instruction for receiving said critical value.

41. The medium of claim 39 wherein said first operating characteristic value corresponds to a first measurement made at said first component.

42. The medium of claim 39 wherein said first operating characteristic value corresponds is an estimate corresponding to said first component.

43. A method for displaying an operating characteristic value, said operating characteristic corresponding to a first component of a commodity transport network, said method comprising:
displaying on a display a first representation of at least a portion of said component; and
using a computer, defining on said display a magnitude axis, said magnitude axis including a plurality of values;
wherein a position, with respect to said axis, of said portion identifies said operating characteristic value.

44. The method of claim 43 further comprising displaying said axis.

45. The method of claim 43 further comprising receiving an evaluation value defined in a dimension parallel to said axis.

46. The method of claim 45 further comprising displaying an evaluation plane perpendicular to said axis, said plane positioned at a value on said axis corresponding to said evaluation value.

47. The method of claim 46 further comprising displaying a second representation of a second component of said network, a position of said second representation indicating a first attribute of said second component.

48. The method of claim 47 wherein said second representation has a visual feature, said feature indicating a second attribute of said second component.
